(19) United States
(12) Patent Application Publication
(10) Pub. No.: US 2010/0201545 A1
(43) Pub. Date: Aug. 12, 2010

(54) METHOD AND SYSTEM FOR MONITORING AND REPORTING COMPARATIVE VEHICLE SPEED AND DIRECTION

(76) Inventors: JAIME NAREA, PARKLAND, FL (US); MARIA S. COLORADO, LONG GROVE, IL (US)

Correspondence Address: JAIME NAREA, 7411 W. CYPRESSHEAD DRIVE, PARKLAND, FL, 33067, US

(21) Appl. No.: 12/368,989

(22) Filed: Feb. 10, 2009

(51) Int. Cl. G08G 1/01; B60Q 1/00; G08G 1/123

(52) U.S. Cl. 340/936; 340/441; 340/436; 340/989

(57) ABSTRACT

A system for monitoring and reporting comparative vehicle speed includes at least one vehicle having a device installed therein, wherein the device includes a transceiver for communicating within a network to one or more monitoring clients, a location receiver for determining a location of the vehicle, a sensor for monitoring a speed of the vehicle, a memory for storing a speed limit database, and a processor operatively coupled between the transceiver, the location receiver, the sensor, the memory, and the alerting mechanism, wherein the processor is programmed to compare the speed of the vehicle to a speed limit associated with the location of the vehicle; and to provide a notification when the speed of the vehicle is above the speed limit associated with the vehicle. The system also includes the one or more monitoring clients for receiving the notification from the at least one vehicle.

### FIELD OF THE DISCLOSURE

The present disclosure relates generally to vehicle performance tracking and more particularly to a method and system for monitoring and reporting a comparative speed and direction of a vehicle.

### BACKGROUND

Parents and insurance companies want instant information about the events in which the teenager drives above the speed limit. Having this information provide parents with the peace of mind that the teenager is driving safely, helps the insurance companies to estimate the level of risk of the young driver, and more importantly may prevent accidents.

Vehicle tracking systems in use today include an electronic device installed in a vehicle to enable the owner or a third party to track the vehicle's location. Most modern vehicle tracking systems use Global Positioning System (GPS) modules for accurate location of the vehicle. Many systems also combine a communications component such as cellular or satellite transmitters to communicate the vehicle's location to a remote user. Vehicle information can be viewed on electronic maps via the Internet or specialized software.

Many vehicle tracking systems now use, or are a form of automatic vehicle location (AVL), to allow for easy location of the vehicle. The GPS satellite system was built and is maintained by government and is available at no cost to civilians. This makes this technology very inexpensive. Other AVL systems do not require the antenna to be in direct line of sight with the sky. Terrestrial based systems such as LORAN and LoJack tracking units use radio frequency (RF) transmitters that will transmit through walls, garages, or buildings. Systems such as GPS Services can use, for example, Global System for Mobile communications/General Packet Radio Service (GSM/GPRS) networks for data transfer to a remote user such as a location center.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for monitoring and reporting comparative vehicle speed and direction in accordance with some embodiments.

FIG. 2 is a block diagram of a device for monitoring vehicle operation in accordance with some embodiments.

FIG. 3 is a block diagram of a server for processing various vehicle performance information in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method is provided for monitoring and reporting comparative vehicle direction and speed comprising within a vehicle: determining a location of the vehicle; monitoring a speed of the vehicle; comparing the speed of the vehicle to a speed limit associated with the location of the vehicle; and providing a notification when the speed of the vehicle is above the speed limit associated with the vehicle. In one embodiment, a method is further provided for monitoring the direction at which the vehicle is travelling; comparing the direction of the vehicle to the permitted direction of the street or road and notifying immediately to the driver if the vehicle is travelling in the opposed direction.

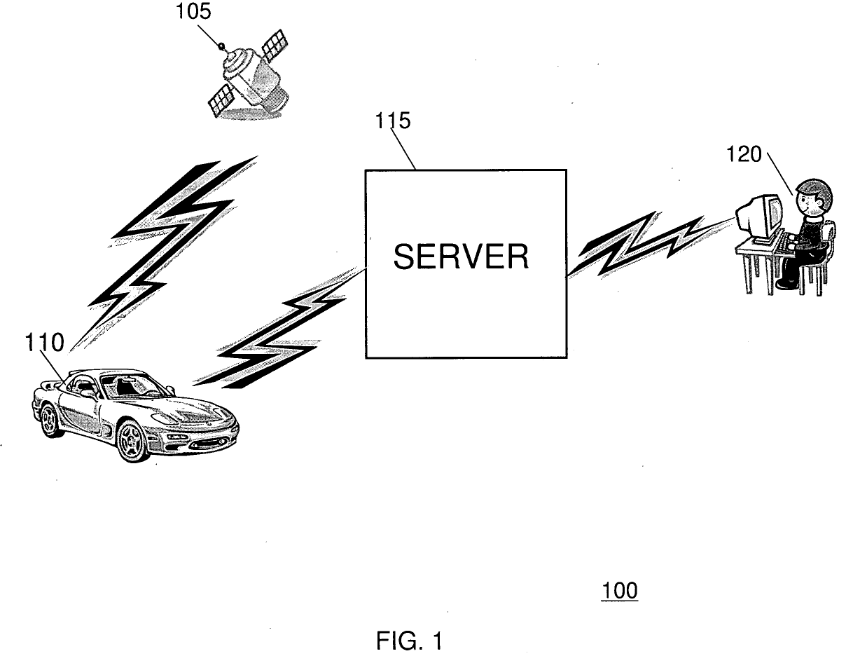

FIG. 1 is a block diagram of a system 100 for monitoring and reporting comparative vehicle speed in accordance with some embodiments. As illustrated, the system 100 includes at least one vehicle communicatively coupled to a global positioning system (GPS) 105 and further communicatively coupled to a server 115. The server 115 is further communicatively coupled to one or more monitoring clients 120. It will be appreciated that one vehicle 110, one GPS system 105, one server 115, and one monitoring client 120 is shown in FIG. 1 for simplicity only and that any number of each element can be implemented within the scope of the present invention.

The system 100, for example, can provide for communication using any wireless radio frequency (RF) channel, for example, a two-way messaging channel, a mobile cellular telephone channel, or a mobile radio channel. The communication system, for example, can include a Wireless Local Area Network (WLAN) system, a Third Generation (3G) Code Division Multiple Access (CDMA) or Global System for Mobile communication (GSM) system, or combinations or future versions of these systems. Similarly, it will be appreciated by one of ordinary skill in the art that one or more of the communication systems can function utilizing other types of wireless communication channels such as infrared channels and/or Bluetooth channels. Similarly, it will be appreciated by one of ordinary skill in the art that one or more of the communication systems can function utilizing a wire line communication channel such as a local area network (LAN) or a wide area network (WAN) or a combination of both. In the following description, the term “communication system” refers to any combination of the communication systems mentioned herein or an equivalent.

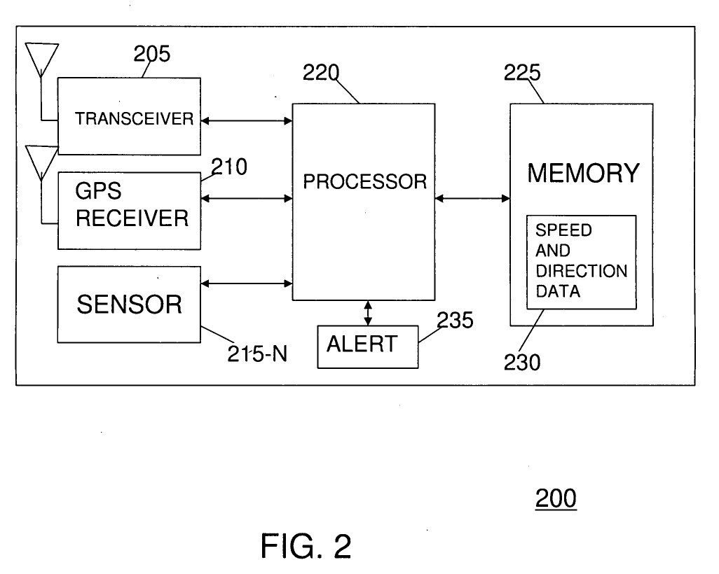

The vehicle 110, in accordance with the present invention, includes a monitoring device to record various performance parameters as will be described in detail with regards to FIG. 2 herein.

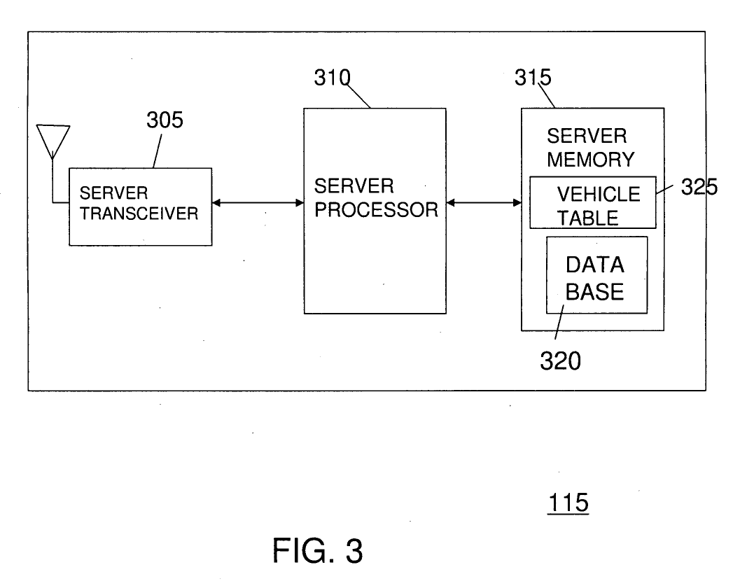

The server 115 receives data such as speed and location from the vehicle for further processing. The server 115 also sends unique distress messages when it receives an accident report from the vehicle. Operation and components of the server 115 will be described in detail with regard to FIG. 3 herein.

The monitoring client 120 can be one or more of an owner of the vehicle, a parent of the operator of the vehicle, an insurance company, a rental car company, a fleet management operator, a monitoring center, and the like. It will be appreciated that the monitoring client 120 can be any entity interested in obtaining information associated with the vehicle speed operation as compared to the speed limits at various locations the vehicle operates within.

At the monitoring client 120, data generated by the server 115 is made available to the consumer. Services such as geo-fencing and arrival time can be part of an interface where the user can access a site to set the fence parameters, set locations for arrival messages and other services. The present invention can also allow insurance companies to access driving statistics and request real time speed data.

FIG. 2 is a block diagram of a device 200 for monitoring vehicle operation operating within the vehicle 110 of FIG. 1 in accordance with some embodiments.

As illustrated, the device 200 includes a transceiver 205, a location receiver such as a GPS receiver 210, one or more sensors 215-N, a processor 220, and a memory 225 where data related to the street or road permitted travelling direction or speed limit direction can reside.

The transceiver 205, via an attached antenna, intercepts transmitted signals from one or more radio frequency networks and transmits signals to the one or more radio frequency networks. The transceiver 205 employs conventional demodulation techniques for receiving the radio frequency communication signals. The transceiver 205 is coupled to the processor 220 and is responsive to commands from the processor 220. When the transceiver 205 receives a command from the processor 220, the transceiver 205 sends a signal via the antenna to one or more other communication systems.

In an alternative embodiment (not shown), the device 200 includes a receive antenna and a receiver for receiving signals from one or more of the RF communication systems and a transmit antenna and a transmitter for transmitting signals to one or more of the radio frequency (RF) communication systems. It will be appreciated by one of ordinary skill in the art that other similar electronic block diagrams of the same or alternate type can be utilized for the device 200.

It will be appreciated by one of ordinary skill in the art that the antenna and transceiver 205 are adapted to communicate within various RF communication systems in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-136 Time Division Multiple Access (TDMA) digital cellular system, the IS-95 Code Division Multiple Access (CDMA) digital cellular system, the CDMA 2000 system, the Wideband CDMA (W-CDMA) system, the Personal Communications System (PCS), the Third Generation (3G) system, the Universal Mobile Telecommunications System (UMTS) and variations and evolutions of these protocols. In the following description, the term “RF communication system” refers to any of the systems mentioned above or an equivalent. Additionally, it is envisioned that RF communication systems can include wireless local area networks, including pico-networks, or the like.

The transceiver 205 is utilized for communicating at least in part with the server 115 for sending information regarding the operation of the vehicle 110 for further processing by the server 115.

The device 200 further includes the GPS receiver 210 for receiving GPS coordinates at periodic intervals. The GPS receiver 210, for example, calculates the position of the vehicle 115 by precisely timing the signals sent by the GPS satellites high above the Earth. Each satellite continually transmits messages containing the time the message was sent, precise orbital information (the ephemeris), and the general system health and rough orbits of all GPS satellites (the almanac). The GPS receiver 210 measures the transit time of each message and computes the distance to each satellite. Geometric trilateration is used to combine these distances with the location of the satellites to determine the receiver's location. The position, for example, the latitude and longitude; and/or elevation information can thereafter be sent to the processor 220 for further processing. The processor 220, for example can derive information such as direction and speed, calculated from position changes received from the GPS receiver 210.

The device 200, further optionally includes one or more sensors 215-n. For example, the one or more sensors 215-n can include a speed sensor for detecting the speed of the vehicle 110. Further, the one or more sensors 215-n can include an inertia chip sensor for capturing the instant in which the vehicle 110 is impacted as in a vehicle accident.

To perform the necessary functions of the device 200, the processor 220 is operatively coupled to the memory 225, which can include a random access memory (RAM), a read-only memory (ROM), an electrically erasable programmable read-only memory (EEPROM), and flash memory. The memory 225, for example, includes memory locations for the storage of one or more received or transmitted messages, one or more software applications, one or more location data, and also for storing permitted traveling direction and speed limit data 230. The stored permitted travelling direction and speed limit data 230 can be, for example, a pre-programmed database of maps with speed limit of each street. This can be, for example, a set of maps that contains the permitted travelling direction and speed limit in each street of a state or country.

It will be appreciated by those of ordinary skill in the art that the memory 225 can be integrated within the device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the device 200. The SIM card can be used to transfer a variety of information from/to the device 200 and/or any other compatible device.

Coupled to the transceiver 205, GPS receiver 210, sensors 215-n, and memory 225, the processor utilizes conventional signal-processing techniques for processing received messages. It will be appreciated by one of ordinary skill in the art that additional processors can be utilized as required to handle the processing requirements of the processor 220. The processor 220, in accordance with the present invention, includes programming to determine and report the speed of the vehicle 110 as compared to the speed limit at a particular location. The processor 220, in one embodiment, determines the speed of the vehicle 110 via an input from a speed sensor. The processor 220, in another embodiment, includes programming for calculating the speed of the vehicle using measured distance coordinates at two or more intervals and a measured time between the two or more intervals. It will be appreciated that the processor 220 programming can be hard coded or programmed during manufacturing, can be programmed over-the-air upon customer subscription, or can be a downloadable application. It will be appreciated that other programming methods can be utilized for programming the processor 220. It will be further appreciated by one of ordinary skill in the art that the processor programming can be hardware circuitry within the device 200.

In accordance with the present invention, when the vehicle 110 is operating, the device monitors constantly the location (via the GPS receiver 210 and/or a location sensor 215), speed (via a speed sensor 215 or other means) of the vehicle 110. The processor 220 receives this information and compares the speed of the vehicle 110 with the speed limit in the street where the vehicle is using the speed limit database 230. Similarly, the processor 220 also receives the vehicle travelling direction 110 and compares with permitted road or street direction database 230.

The device 200 can optionally include an alert 235 for notifying the driver of the vehicle the instant that it is passing the speed limit so that it gives the driver a chance to reduce the speed before the system sends the message. The time and threshold of the warning time can be determined by the driver, the server, or the monitoring client in alternative embodiments.

The alert 235 can include an audible alert such as a speaker with associated speaker drive circuitry capable of playing melodies and other audible alerts. The alert 235 similarly can include a tactile alert such as a vibrator with associated vibrator drive circuitry capable of producing a physical vibration. The alert 235 similarly can include a visual alert such as one or more light emitting diodes (LEDs) with associated LED drive circuitry and/or a visual display with associated display drive circuitry, each capable of producing a visual alert. The alert 235 similarly can include a voice synthesized alert capable of producing a voice synthesized output alerting the driver of a over the limit speed or if it is driving against the permitted road or steet direction (ie; entering or exiting espressways, etc). The alert 235 similarly can include a haptic alert capable of producing a haptic output such as a scent. It will be appreciated by one of ordinary skill in the art that other similar alerting means as well as any combination of the audible, vibratory, visual, and haptic alert outputs herein described can be used for the alert 235. Such alert device 235 can be located away from the device 200 (passenger side, inside the vehicle) and the information sent from device 200 to device 215 be via any local area wireless technology such that the driver could, if desired, make a receive calls.

In operation, the device 200, in one embodiment uses GPS and a cellular technology device installed in the vehicle to evaluate the speed of the driver and compare with the speed limit of the street or road the driver is riding on. If the vehicle is moving above said speed limit, the installed vehicle device will first alert the driver of this event for a period of time, (for example, 5 seconds) and continuously monitor the speed, if after a second period of time (for example, 10 seconds) the speed is still above the permissible speed limit, the device will notify the server to send notification to one or more monitoring clients. For example, a message (text, GPRS, graphic image, etc) could be sent to some pre-programmed phone numbers. The phone numbers can be a monitor center from an insurance company, family, etc. The monitor center can store this event in a database that can be checked at any time by the insurance company. In addition to notifying the speed, the system can also inform the parent if the teenager moves beyond certain area so he is aware when the teenager leaves a safety zone (i.e. town, school campus etc).

The device installed in the vehicle will also be able to detect the impact of an accident and upon occurrence will send a message to the pre-programmed phone numbers (911 emergency, insurance, etc) alerting them of the accident and the location where the vehicle is. This instant accident notification is a service that helps to provide immediate assistance to the driver.

FIG. 3 is a block diagram of a server 115 for processing various vehicle performance information, in accordance with some embodiments. As illustrated, the server includes a server transceiver 305, a server processor 310, and a server memory 315 including a stored database 320.

The transceiver 305 operates to communicate with various vehicles and various monitoring clients by communicating via an attached antenna, intercepts transmitted signals from one or more radio frequency networks and transmits signals to the one or more radio frequency networks. The transceiver 305 employs conventional demodulation techniques for receiving the radio frequency communication signals. The transceiver 305 is coupled to the server processor 310 and is responsive to commands from the server processor 310. When the transceiver 305 receives a command from the server processor 310, the transceiver 305 sends a signal via the antenna to one or more other communication systems.

In an alternative embodiment (not shown), server 115 includes a receive antenna and a receiver for receiving signals from one or more of the RF communication systems and a transmit antenna and a transmitter for transmitting signals to one or more of the radio frequency (RF) communication systems. It will be appreciated by one of ordinary skill in the art that other similar electronic block diagrams of the same or alternate type can be utilized for the server 115.

It will be appreciated by one of ordinary skill in the art that the antenna and transceiver 305 are adapted to communicate within various RF communication systems in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-136 Time Division Multiple Access (TDMA) digital cellular system, the IS-95 Code Division Multiple Access (CDMA) digital cellular system, the CDMA 2000 system, the Wideband CDMA (W-CDMA) system, the Personal Communications System (PCS), the Third Generation (3G) system, the Universal Mobile Telecommunications System (UMTS) and variations and evolutions of these protocols. In the following description, the term “RF communication system” refers to any of the systems mentioned above or an equivalent. Additionally, it is envisioned that RF communication systems can include wireless local area networks, including pico-networks, or the like.

Coupled to the transceiver 305, the server processor 310 utilizes conventional signal-processing techniques for processing received messages. It will be appreciated by one of ordinary skill in the art that additional processors can be utilized as required to handle the processing requirements of the server processor 310. The server processor 310, in accordance with the present invention, includes programming to receive information from one or more vehicles of the vehicles current speed and location, to compare the speed to the speed limit at the location by accessing the stored database 320, and to send information related thereof to one or more monitoring clients subscribing to receive information for that vehicle. Alternatively, the server processor 310 can receive notification directly from the vehicle that it is speeding and send that information to the one or more monitoring clients subscribing to receive information for that vehicle.

It will be appreciated that the server processor 310 programming can be hard coded or programmed during manufacturing, can be programmed over-the-air upon customer subscription, or can be a downloadable application. It will be appreciated that other programming methods can be utilized for programming the server processor 310. It will be further appreciated by one of ordinary skill in the art that the processor programming can be hardware circuitry within the server 115.

To perform the necessary functions of the server 115, the server processor 310 is operatively coupled to the server memory 315, which can include a random access memory (RAM), a read-only memory (ROM), an electrically erasable programmable read-only memory (EEPROM), and flash memory. The server memory 315, for example, includes memory locations for the storage of one or more received or transmitted messages, a table of monitored vehicles and associated monitoring clients 325, one or more software applications, and also for storing a speed limit database 320. The stored speed limit database 320 can be, for example, a pre-programmed database of maps with speed limit of each street. This can be, for example, a set of maps that contains the speed limit in each street of the country.

In addition to the security and safety applications described herein, the present invention can be incorporated with and provide beneficial capabilities for other applications such as connection to the police to generate tickets, or providing the data to other insurance companies, or determining the areas in the city where the speed limit is more likely to be exceeded. Another potential application is to partner with a security organization to provide immediate assistance in case of accident.

It will be further appreciated that the methods and systems described herein can be beneficially implemented for alerting a driver of the vehicle of other information such as the direction of the street (notification of driving in the wrong direction etc), high degree of accident alerts (i.e. server check a database of high accidents rate and inform the driver using a color code), and the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for monitoring and reporting comparative vehicle speed comprising:
within a vehicle:
determining a location of the vehicle;
monitoring a speed of the vehicle;
comparing the speed of the vehicle to a speed limit associated with the location of the vehicle; and
providing a notification when the speed of the vehicle is above the speed limit associated with the vehicle.

2. A method as claimed in claim 1, further comprising:
repeating the determining, monitoring, comparing and providing of a notification steps at periodic intervals.

3. A method as claimed in claim 2, wherein the periodic intervals comprise one of an interval of time, an interval of location change, an interval of speed changes.

4. A method as claimed in claim 1, wherein the location of the vehicle is determined using at least one of a global positioning system (GPS) receiver and a location sensor.

5. A method as claimed in claim 1, further comprising:
storing a the speed limit database in a memory of the vehicle, wherein the speed limit database comprises the speed limit associated with each of a plurality of locations, and further wherein the comparing step comprises comparing the speed of the vehicle with the speed limit stored in the speed limit database for the location.

6. A method as claimed in claim 1, wherein the providing the notification step comprises:
alerting the driver of the vehicle when the vehicle is greater than the speed limit.

7. The method as claimed in claim 1, wherein the providing the notification step comprises:
alerting the driver of the vehicle when the vehicle speed is passing the speed limit.

8. The method as claimed in claim 1, wherein the providing the notification step comprises alerting the driver at a time and a threshold, wherein the time and the threshold are set by at least one of the driver, a system server, and a monitoring client.

9. A method as claimed in claim 1, wherein the providing the notification comprises alerting the driver using at least one of an audible alert, a vibratory alert, a visual alert, and a haptic alert.

10. A method as claimed in claim 1, wherein the providing the notification comprises:
transmitting a message to alert a remotely located monitoring client when the speed of the vehicle is greater than the speed limit at the location.

11. A method as claimed in claim 1, wherein the providing the notification comprises:
alerting the driver of the vehicle that the vehicle speed is greater than the speed limit at the location;
repeating the determining, monitoring, and comparing steps after a predetermined time; and
transmitting a message to alert a remotely located monitoring client when the speed of the vehicle continues to be greater than the speed limit.

12. A method as claimed in claim 1, further comprising:
transmitting the results of the comparing step to a server on a periodic basis;
storing the speed comparing results in the server as received on the periodic basis; and
providing a historical analysis of the speed comparing results from the server to one or more monitoring clients.

13. A method as claimed in claim 1, further comprising:
transmitting the speed and location of the vehicle from the vehicle to a server on a periodic basis;
comparing the speed of the vehicle to a stored speed limit for the location of the vehicle at the server; and
reporting the results of the comparing step by the server to one or more monitoring clients.

14. A method as claimed in claim 13, further comprising:
repeating the transmitting and comparing steps on a periodic basis:
storing the speed comparing results in the server as received on the periodic basis; and
providing a historical analysis of the speed comparing results from the server to one or more monitoring clients.

15. A method as Claimed in claim 1, further comprising:
detecting an impact of the vehicle; and
reporting the impact of the vehicle to one or more monitoring clients.

16. A system for monitoring and reporting comparative vehicle speed comprising:
at least one vehicle having a device installed therein, wherein the device comprises:
a transceiver for communicating within a network to one or more monitoring clients,
a location receiver for determining a location of the vehicle,
a means for monitoring a speed of the vehicle,
a memory for storing a speed limit database, and
a processor operatively coupled between the transceiver, the location receiver, the sensor, the memory, and the alerting mechanism, wherein the processor is programmed to compare the speed of the vehicle to a speed limit associated with the location of the vehicle; and to provide a notification when the speed of the vehicle is above the speed limit associated with the vehicle;
the one or more monitoring clients for receiving the notification from the at least one vehicle.

17. A system as claimed in claim 16, wherein the means for monitoring the speed of the vehicle comprises a sensor.

18. A system as claimed in claim 16, wherein the means for monitoring the speed of the vehicle comprises a processor for calculating the speed using measured distance coordinates at two or more intervals and a measured time between the two or more intervals.

19. A system as claimed in claim 16, further comprising:
a server coupled between the at least one vehicle and the one or more monitoring clients, the server programmed to receive the notification from the at least one vehicle, to store each received notification, and to provide a speed to speed limit historical comparison to the one or more monitoring clients.

20. A system as claimed in claim 19, wherein the device within the at least one vehicle further comprises:
